(19) United States
(12) Patent Application Publication
(10) Pub. No.: US 2012/0031440 A1
(43) Pub. Date: Feb. 9, 2012

(54) MOBILE CLEANING EQUIPMENT

(76) Inventor: Dean William Crompton, Surrey (GB)

(21) Appl. No.: 13/131,064

(22) PCT Filed: Nov. 25, 2009
(86) PCT No.: PCT/GB09/51599

§ 371 Date: Sep. 23, 2011

(30) Foreign Application Priority Data
Nov. 25, 2008 (GB) 0821460.3

(51) Int. Cl. B08B 3/02; B08B 7/00

(52) U.S. Cl. 134/104.4

(57) ABSTRACT

Mobile cleaning equipment comprising a powered wheeled vehicle (50) with an integral driver's cab (51) containing vehicle drive controls and a water supply tank (52) carried by the vehicle (50). The vehicle (50) also has a ground- or floor-engageable cleaning head (88) having, outlet jets and also a peripheral suction channel. A powered pressure pump (60) connected between the water supply tank (52) and the outlet jets of the cleaning head (88), and a rotary suction device (84) is connected between the suction inlets and the water supply tank (52). The mobile cleaning equipment also comprises at least one filter (85, 74, & 75) arranged between the water supply tank (52) and said powered pressure pump (60).

This invention relates to mobile cleaning equipment, for use in cleaning walls, ground or floor surfaces particularly in external environments.

Paved pedestrian areas, and other wall, ground or floor surfaces which are exposed to the environment and/or which are regularly used by the general public, may require frequent cleaning for hygiene, safety and/or aesthetic reasons.

Mobile scrubber/dryer equipment is used for this purpose, such equipment having a rotary ground-engaging brush combined with a water solution supply and also a suction device which collects supplied solution and dries the ground surface. The equipment may be a self-contained push-along unit having ground wheels, steering and control handles, on-board solution and water recovery tanks, and battery-powered drive motors for the rotary brush, a solution delivery system, and a suction device. Battery-powered sit-on mobile scrubber/dryers are also known.

Known scrubber/dryer equipment is convenient to use but may not be effective in cleaning surfaces which are heavily stained or which are contaminated with chewing gum or other materials which are not readily removed by washing and brushing.

It is known to remove chewing gum with pressurised hot water or steam jets using hand-held lances. However, this can be difficult and time-consuming, and the process may result in unacceptably large quantities of water running-off to drainage. Additionally, such pressurised jets leave the water which is dirty on the pavement, and this can dry and leave dirty surfaces.

It is further known, as described in EP 1006854A, to use a towed trailer having water supply and water collection tanks connected via supply and collection hoses to a push-along wheeled cleaning head. The head has an open-bottomed dome which contains outlet jets and also rotor arms with ground-engaging flexible seals. The jets are supplied with pressurised hot water using a water heater and an engine-powered pump on the trailer. The rotor arms are rotated by an engine or battery-powered motor mounted on the dome, so as to impel ground water to a channel around the periphery of the dome and, from there, via a duct, to the water collection tank on the trailer. Collected water is recycled, via a filter tank, which may be under reduced pressure, back to the supply tank.

This known tower trailer arrangement relies on a relatively large number of complicated power sources and operational devices and is therefore expensive to manufacture and maintain. Arrangements are also known which use a sit-in vehicle rather than a towed trailer and which also rely on a relatively large number of complicated devices.

An object of the present invention is to provide effective cleaning equipment which is convenient to use and relatively simple and inexpensive to manufacture and maintain.

According to a first aspect of the invention therefore there is provided mobile cleaning equipment comprising:

a powered wheeled vehicle with an integral driver's cab containing vehicle drive controls;

water supply tank carried by the vehicle,

a ground- or floor-engageable cleaning head having, beneath a cover, outlet jets and also a peripheral suction channel having, between spaced-apart flexible side walls, a plurality of suction inlets,

a powered pressure pump connected between the water supply tank and the outlet jets of the cleaning head,

at least one filter arranged between the water supply tank and said powered pressure pump,

and a rotary suction device connected between the suction inlets and the water supply tank.

With this arrangement effective cleaning can be achieved with equipment which can be easy and convenient to use and, in so far as it relies on a relatively small number of simple operational devices, relatively inexpensive to manufacture and maintain. Additionally, as the water which is used for cleaning is recovered in to the water supply tank and re-used after passing through the filters, the mobile cleaning equipment achieves high rates of recycling of the water. This reduces the amount of water needed to use the equipment, and also allows operation for longer periods between re-filling of the water supply tank.

The vehicle may have a front cab, which may be open or enclosed, in front of an open or enclosed platform or van body carrying the tank and other devices.

The vehicle is preferably a battery-powered vehicle and may be generally of the format of a golf-cart or similar. Most preferably, motive power is derived solely from a battery source i.e. with no internal combustion or other fuel-burning engine.

The vehicle where battery powered may also comprise a battery charging point which can be attached to a power source allowing for charging of the vehicle batteries. Alternatively, the batteries may be removable such that drained or nearly drained batteries can be exchanged for fully charged batteries.

Preferably, where the vehicle is battery-powered, the powered pressure pump and the rotary suction device may both be powered by direct current which is supplied by the battery. This arrangement would allow for the vehicle and the cleaning equipment to be powered solely by the battery and would allow for the vehicle to be manufactured without a combustion engine thereby reducing weight and maintenance. Additionally, such a vehicle would be suited in particular for operation at one site at which the vehicle would not require a long range and could be returned to a charging point.

The rotary suction device may be a suction or vacuum pump.

The powered pressure pump may be comprised within a pressure washer unit.

The tank may take any suitable form. Typically a 1000 litre metal and/or plastics tank may be used.

The mobile cleaning equipment comprises at least one filter. The filter is arranged to allow for the water to be filtered after it has been sucked up from the cleaning head during use, and before the water is used again in the cleaning head.

The purpose of the at least one filter is therefore to remove any matter or material contained in the water and prevent clogging of the pumps. Additionally, the filtered water may then be re-used in the cleaning head.

The at least one filters are preferably in-line with the pressurised water pump.

Preferably, the at least one filter may be a plurality of filters. Said plurality of filters may operate in-line and provide for sequential removal of decreasing sizes of matter and material from the sucked up water.

The plurality of filters may comprise a first stage filter or pre-filter arranged between the rotary suction device and the water tank to remove material from the dirty water. The pre-filter may preferably be arranged to filter the dirty water upon entry to the water tank after use in the cleaning head.

The first stage filter may have a filter size of 80 to 240 μm. Preferably, the filter size is in the range 100 to 200 μm. The first stage filter may comprise one or a plurality of bag filters.

There may also be further filters arranged between the rotary suction device and the pressurised water pump. Preferably, said further filters comprise a second stage filter having a filter size in the range 20 to 40 μ. More preferably, the second stage filter may have a filter size of 30 μm. The second stage filter may be one or more disk filters.

The further filters may comprise a third stage filter having a filter size in the range 5 to 10 μm. The third stage filter may be one or more carbon black filters.

The filters may have a transparent panel so that they may be viewed by a user of the mobile cleaning equipment. This would allow for the user to identify how dirty the filters are and also enable the user to ascertain when they may need to be cleaned or replaced. Alternatively, the filters may have an associated inspection panel which is removable to allow for inspection or replacement of each filter.

The filters may be arranged such that they are easily removable from the mobile cleaning equipment for cleaning or replacement. Valves or taps may be arranged on one or each side of each filter to allow for isolation of each filter prior to removal.

It is envisaged that the water once filtered may be sufficiently clean such that it could be disposed of down a drain. Typically, unfiltered water used for street cleaning cannot be disposed of in this way.

The filtered water may be returned to the water supply tank for later use, or may pass directly to the pressurised water pump for immediate use in the cleaning head.

The water supply tank may comprise at least one float switch which is adapted to stop the rotary suction device or pressurised water pump should the level of water in the tank reach a maximum or minimum level. This would prevent overflow of the water supply tank (for example if rainwater was also sucked up by the cleaning head), or sucking of air in to the pressurised water pump.

The cleaning head may be mounted on the vehicle so as to be moved, in use, by movement of the vehicle. Thus, the head may be located, when in use, beneath the vehicle or in front of the vehicle or behind the vehicle. In this case the head may be connected to the vehicle via a movable arm or other extendable or adaptable structure so that the head can be moved between an out-of-use stowed or retracted position and an extended or displaced in-use position. In the in-use position the cleaning head preferably engages the floor or ground surface and rollers or wheels may be provided to facilitate movement over the surface.

Alternatively or additionally, the cleaning head may be separate from the vehicle and may be provided with ground engaging rollers or wheels and/or handles or the like, so that it can be used on a manual push-along basis separately from the vehicle. In this case, connection to the tanks may be effected via flexible hoses which conveniently may be stored in reels on the vehicle. Provision may be made for stowing the cleaning head on the vehicle when not in use.

With regard to the cleaning head, the cover may comprise an open-bottomed dome structure or the like. The outlet jets may comprise multiple spaced apart jets distributed beneath the dome directed downwardly and these may be at fixed positions or on rotatable arms or otherwise. If desired, the cleaning head may also have a ground- or floor-engaging brush which may be beneath the cover and which may be fixed or movable e.g. rotatable.

The cleaning head may comprise at least one flexible resilient member arranged around the periphery of the cleaning head. The side walls of the cleaning head may therefore comprise rubber and/or plastics flaps or blades or the like. This flexible resilient member may preferably be in the form of a rubber blade or squeegee. Said member may be arranged around the entire circumference of the cleaning head, or alternatively may be arranged around a portion of the cleaning head.

The at least one flexible resilient member may be affixed to the cleaning head using a clamp arranged on the exterior peripheral surface of the cleaning head.

The at least one flexible resilient member allows for prevention of water escaping from the cleaning head, and therefore allow a higher proportion of the water to be sucked up and recycled thereby reducing any refilling of the mobile cleaning equipment. The at least one flexible resilient member also facilitates maintaining the vacuum in the cleaning head.

The suction inlets may comprise multiple small holes or slits, slots, channels or the like in one or more rows directed downwardly.

The peripheral suction channel may be arranged around the entire periphery of the cleaning head. Alternatively, the peripheral suction channel may be arranged around a portion of the cleaning head.

Preferably, the peripheral suction channel is arranged around half the circumference of the cleaning head such that it is positioned around the rear half. In such an arrangement, the front circumference half of the cleaning head may have a flexible resilient member affixed to the outer edge, said resilient member having a plurality of serrations. Said serrations may be substantially vertical. The serrations would allow for entry of air in to the underside of the cleaning head thereby preventing any excessive build-up of vacuum.

It has been advantageously found that having the peripheral suction channel arranged around a portion of the cleaning head allows for easier movement of the cleaning head across a surface when in use.

The mobile cleaning equipment may comprise a water heater, and may be mounted on the vehicle. The heater may be powered by a battery. The water heater may be arranged such that it can heat the water prior to use in the cleaning head. The water heater may be controllable for producing water heated to a desired temperature and/or steam.

The powered pressure pump, may be mounted on the vehicle whereby a duct, which may be flexible, such as one of the aforesaid hoses, is provided for connection to the cleaning head. The powered pressure pump, may be battery-powered or engine e.g. diesel-engine operated.

The rotary suction device may be mounted on the vehicle whereby a duct, which may be flexible, such as one of the aforesaid hoses, may be provided for connection to the cleaning head. The device may have driven rotor blades within a housing with inlet and outlet connections. The suction device may be battery-powered.

The mobile cleaning equipment may also comprise other cleaning apparatus in addition to the cleaning head. Such additional cleaning apparatus may comprise hoses which can provide high pressure water. Additional cleaning apparatus may also include a suction hose which is associated with said high pressure water hose.

The additional cleaning apparatus may be arranged at a suitable position on the mobile cleaning equipment, for example they may be arranged on hose reels at the rear of the vehicle to allow for use of the hoses when unreeled, and storage of the hoses on the reels when not in use. The additional cleaning apparatus may be attached to the rotary suction device and pressurised water pump of the mobile cleaning equipment. Alternatively, the additional cleaning apparatus may be attached to separate pumps.

The additional cleaning apparatus, such as the high pressure water hose, may be used to remove particularly difficult dirt such as chewing gum residue on pavements. The high pressure water may remove the gum with the cleaning head subsequently being passed over the same area to provide for a uniform clean surface.

Further advantages of the mobile cleaning equipment of the first aspect include the equipment being self-contained, having a relatively simple design, and compact making it commercially viable on a wider scale. Additionally, as the equipment allows for high levels of water recycling in the system the water tank does not require routine emptying and refilling. The mobile cleaning equipment provides for the water to be sufficiently filtered and recycled both during and after cleaning use. Any shortfall in recovery of water due to leakage from the cleaning head is replaced by refilling the water tank to the “fill level” via the mains supply.

The low water usage of the mobile cleaning equipment due to the recycling and filtration of the water after cleaning provides a more environmentally friendly cleaning method. Each stage of filtration is designed to ensure the solids are contained and managed to facilitate easy disposal into the foul sewer and not the water surface drain.

It is also possible to have mobile cleaning equipment which uses an alternative arrangement to that which is described in the first aspect.

According to a second aspect of the invention therefore there is provided mobile cleaning equipment comprising:

a powered wheeled vehicle with an integral driver's cab containing vehicle drive controls;

separate water supply and water retrieval tanks carried by the vehicle,

a ground- or floor-engageable cleaning head having, beneath a cover, outlet jets and also a peripheral suction channel having, between spaced-apart flexible side walls, a plurality of suction inlets,

a powered water heater and pressure pump connected between the water supply tank and the outlet jets of the cleaning head,

and a rotary suction device connected between the suction inlets and the water retrieval tank.

The tanks may take any suitable fowl and may be of the same or different capacity, preferably the same capacity. Typically 1000 litre metal and/or plastics tanks may be used. It is also possible to use a single tank divided by a membrane into separate compartments.

Conveniently the tanks or compartments may be wholly separate and unconnected i.e. such that supplied water is derived solely from the supply tank, and retrieved water is retained in the retrieval tank, without being recycled to the supply tank, for subsequent disposal. This avoids complications and costs involved with filtration and recycling.

The mobile cleaning equipment may perform the same functions as described with regard to the first aspect. Additionally, it is envisaged that all the features described with reference to the first aspect may be combined with the second aspect.

Prior surface cleaners which have higher recovery rates of the cleaning water are typically difficult to manoeuvre, whilst adjustment to allow more air flow increases manoeuvrability yet decreases the recovery performance.

The mobile cleaning equipment of the present invention allows for both a high recovery rate of the water used and a good degree of manoeuvrability, this may be achieved using a cleaning head having a combination of leading serrated squeegee blade to allow incoming air flow and a “rear only” vacuumated channel which concentrates and accelerates the suction at the rear rather than around the entire perimeter of the cleaning head.

In order that the present invention may be more readily understood, reference will now be made, by way of example, to the following description and accompanying drawings, in which;

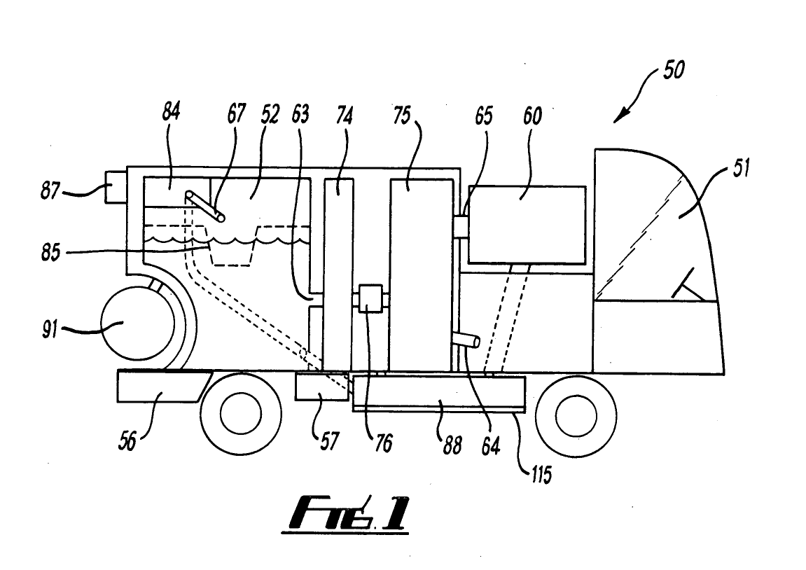

FIG. 1 is a schematic side view of mobile cleaning equipment in accordance with the first aspect of the present invention;

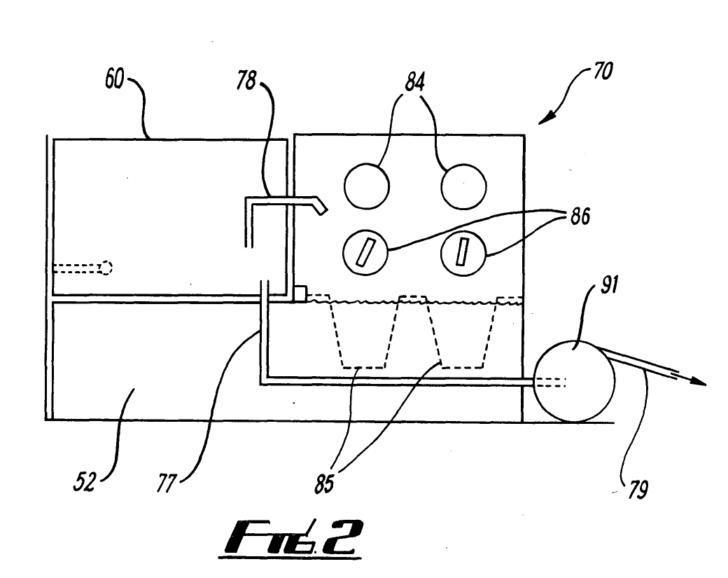

FIG. 2 is a schematic side view of an alternative mobile cleaning equipment in accordance with the first aspect of the present invention;

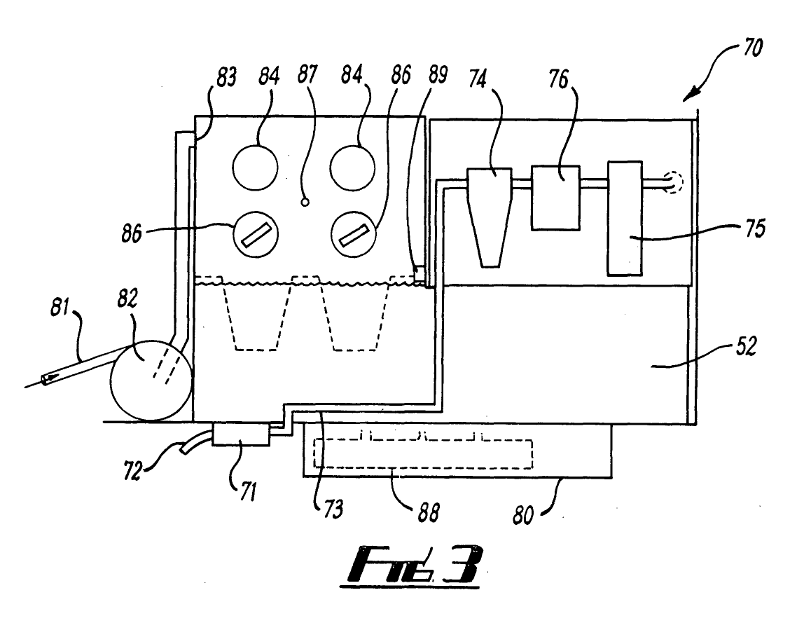

FIG. 3 is a further schematic side view of the mobile cleaning equipment of FIG. 2;

FIG. 4 is a schematic rear view of the mobile cleaning equipment of FIGS. 2 and 3;

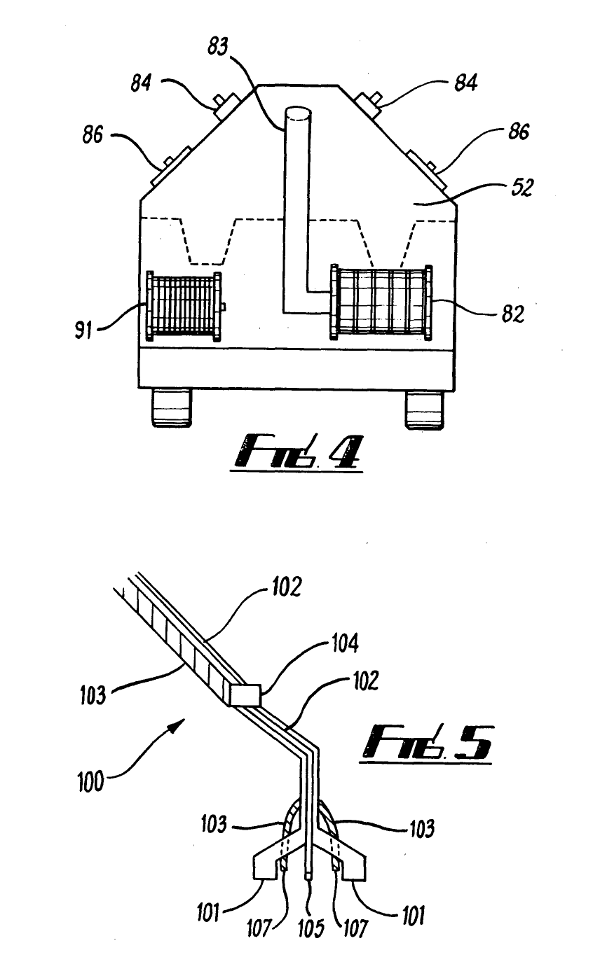

FIG. 5 is a schematic section side view of a handle for a cleaning head;

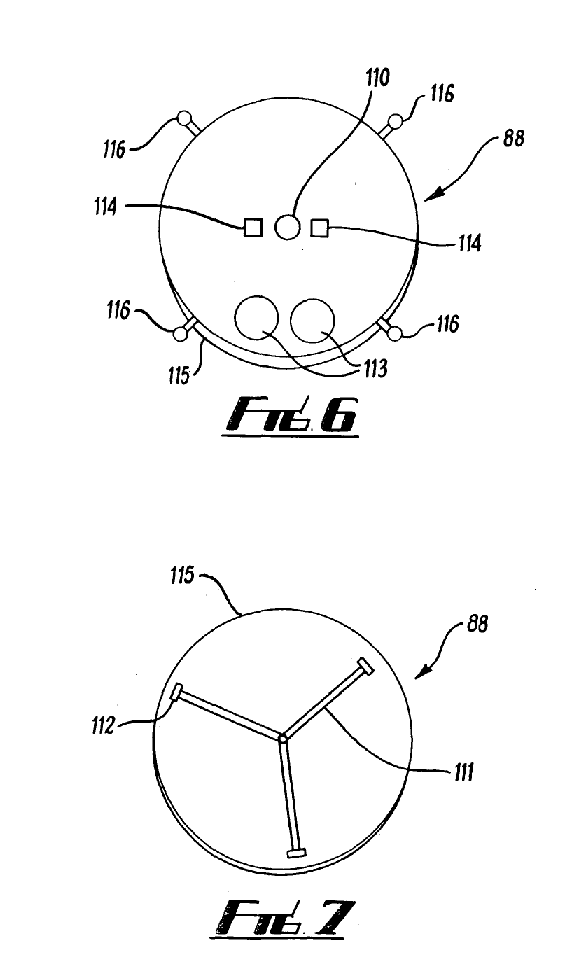

FIG. 6 is a schematic top view of a cleaning head;

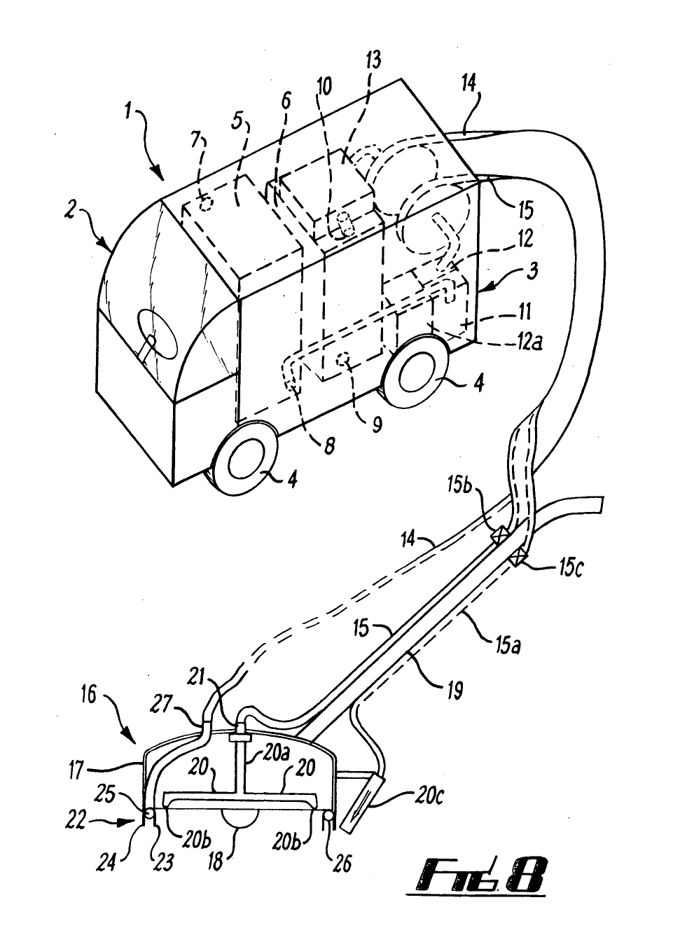

FIG. 7 is a schematic bottom view of the cleaning head of FIG. 6; and

FIG. 8 is a schematic perspective view of mobile cleaning equipment in accordance with the second aspect of the present invention with part of the equipment shown enlarged and in cross-section.

Referring to FIG. 1, there is shown a mobile cleaning equipment vehicle 50. The vehicle 50 is a wheeled vehicle 50 having a forward end enclosed cab 51.

The chassis of the vehicle 50 has an electrical motor assembly and battery power source 56 which is connected to the wheels, and which provides motive power for the vehicle 50. The cab 51 contains drive controls including a steering wheel for use by a driver seated within the cab 51. The vehicle 50 also has a charging point 57 which can be connected to a power source to charge the battery power source 56.

Behind the cab 51 there is positioned a water tank 52 which is provided with a filler inlet 87 and a filter inlet 63. The tank 52 is also provided with a discharge outlet 64 to allow for draining of the tank 52. The tank 52 also has a retrieval inlet 67. On passing out of the retrieval inlet 67 the dirty water passes through a bag filter 85 having a pore size of 150 μm to removing dirt prior to entering the water tank 52.

The filter inlet 63 is connected to two sequential filters 74 and 75. The filters 74 and 75 are of various pore sizes such that they remove matter from the water passing therethrough. The second stage filter 74 has a pore size of 30 μm. The water then passes to a third stage filter 75 which is a carbon black filter. The third stage filter 75 has a filter outlet 65 which is connected to a pressurised water pump 60.

The vehicle 50 contains a pressurised water pump 60 which receives filtered water via the filter outlet 65. The pressurised water pump 60 is connected to a cleaning head 88, and the pump 60 supplies pressurised water to the cleaning head 88.

The cleaning head 88 is shown in a stored position underneath the vehicle 50. During use, the cleaning head 88 would be lowered so that it would be in contact with the surface to be cleaned.

The cleaning head 88 contains a star shaped arrangement of three horizontal tubes extending radially from a central point (not shown). Water flowing from the pump 60 enters the central point of the star arrangement and flows to the end of the tubes to an outlet where it can be sprayed on to the surface to be cleaned. The outlets are arranged at an angle of 40° to vertical plane thereby causing the star shaped arrangement to rotate when pressurised water is passed through.

There is arranged around the entire periphery of the cleaning head 88 a rubber wall or blade 115. This rubber wall 115 forms a seal with the surface to be cleaned when the cleaning head 88 is lowered in to a cleaning position, and thereby reduces leakage of water from the cleaning head 88. In this way, the water containing any dirt from the cleaned surface is kept within the cleaning head 88 for suction back in to the water tank 52.

The cleaning head 88 contains within the peripheral rubber wall 66 a channel which has suction inlets. The dirty water is collected from the cleaned surface by the suction inlets and passes back to the water tank 52 via the retrieval inlet 67.

The dirty water in the water tank 52 is then filtered again prior to use in the cleaning head 88 by the aforementioned filters 85, 74, and 75.

There is a vacuum pump 84 arranged between the cleaning head and the water tank 52, and this pump 84 provides suction to the cleaning head 88 for sucking dirty water back towards the water tank 52.

There is arranged a suction pump 76 between the first stage filter 85 and the second stage filter 74 which draws the water from the water tank 52 through the filters 85, 74, and 75 towards the pressurised water pump 60. The first stage filter 85 is arranged between the vacuum pump 84 and the water tank 52 in order to filter any material which may otherwise block the tank 52 or subsequent filters 74, 75 and pressure washer 60.

The battery power source 56, in addition to providing motive power, also provides power for the vacuum pump 84, suction pump 76, and pressurised water pump 60.

At the rear of the vehicle there are high pressure hoses and suction hoses arranged on a reel 91. These hoses receive high pressure water from the pressurised water pump 60, and the suction hose is connected to the water tank 52. The hoses allow the vehicle user to remove stubborn contamination, such as chewing gum, by high pressure water.

Referring to FIGS. 2 and 3 there are shown opposing side schematic views of cleaning apparatus 70 for a vehicle having an alternative arrangement to that shown in FIG. 1. FIGS. 2 and 3 show the cleaning apparatus 70 arrangement only and do not show the vehicle features for the purposes of clarity. There is shown a water tank 52 which has a tank sump 71 arranged at a lower surface. The tank sump 71 contains a drain 72 which allows for draining of the water tank 52, and also a feed line 73 for connection and feeding of water to the filtration assembly.

The filtration assembly consists of a disk filter 74 and housing which has a filter size in the region of 20-40 μm. The water passes through this disk filter 74 on to a further filter 75 which is a carbon filter contained in a cartridge housing. This further filter 75 has a filter size in the region of 5-10 μm. Arranged in between the filters 74, 75 is a pump 76.

Once the water has been filtered sufficiently for use in the cleaning head 88, the water passes in to the pressure washer 60. The pressure washer 60 contains an outlet for a high pressure hose feed 77 from the washer 60 to the high pressure hose reel 91. Additionally, the pressure washer 60 also has an overflow feed back 78 to the water tank 52.

The high pressure water is fed in to the high pressure hose 79 via the high pressure hose reel 91. The hose 79 is then attached to the cleaning head 88.

The cleaning head 88 is shown in FIG. 3 in a stored position in a compartment 80 below the water tank 52. When required for cleaning a surface, the cleaning head 88 is removed from the storage compartment 80 and attached to the high pressure hose 79. Additionally, the cleaning head 88 is attached to the suction recovery hose 81. This suction recovery hose 81 acts to direct the dirty water sucked form the cleaning head 88 to the suction hose reel 82 and to an inlet 83 for the water tank 52 positioned at a high level. The suction is provided by vacuum pumps 84 arranged above the water tank 52.

The dirty water enters the water tank 52 and passes through bag filters 85 having a filter size of between 100-200 μm. This provides for a “coarse” filtration of the dirty water on entry to the water tank 52.

Above each bag filters 85 at an angle of 45° to the vertical plane are arranged inspection covers 86. These covers 86 can be removed by the user and allow for inspection and replacement of the bag filters 85.

There is also arranged on a surface of the cleaning assembly 70 a water refill point 87 which allows for attachment to a water source. It can be seen that the water used in the mobile cleaning equipment is substantially reused and recycled. However, a small amount of water is likely to be lost from the cleaning head 88 during normal operation. Therefore, the refill point allows for water to be added to the mobile cleaning equipment.

There is also a level sensor 89 arranged on the inside surface of the water tank 52 which is able to detect the water level in the tank 52. The level sensor 89 can shut off the vacuum pumps 84 on detecting a high level of water in the tank 52, and can shut off the pressure washer 60 on detecting a low level of water in the tank 52.

Referring to FIG. 4, there is shown a rear schematic view of the cleaning apparatus as shown in FIGS. 2 and 3 as mounted on a vehicle. The rear view shows the high pressure hose reel 91 and suction hose reel 82 arranged at either side of the rear of the vehicle. The suction hose reel 82 feeds in to the water tank 52 via an inlet 83.

The rear view also shows the vacuum pumps 84 arranged on the top of the water tank 52, and also the inspection covers 86 for inspecting and replacing the bag filters.

Referring to FIG. 5 there is shown a schematic cross-section side view of a surface cleaner handle 100. The handle 100 is for use between the vehicle and a cleaning head and can be hand operated by a user or arranged between the vehicle body and cleaning head such that the cleaning head moves with the vehicle. The handle 100 comprises securing means 101 being spring loaded securing pins for connection to the securing points of the cleaning head.

The handle 100 also comprises a high pressure hose feed 102 which terminates at a hose connection 105 for connecting to high pressure hose connection point on the cleaning head. Additionally, the handle 100 comprises a suction hose 103 which terminates at a connection 106 for connecting to suction hose connection points on the cleaning head.

The handle 100 also has a pressure gun or trigger 104 which allows the user to turn on and off the high pressure water flow.

Referring to FIG. 6, there is shown a top schematic view of the cleaning head 88 as shown in FIG. 3. Referring to FIG. 7, there is shown an underside schematic view of the cleaning head 88 of FIG. 6. The cleaning head 88 has a centrally located high pressure hose connection point 110 for allowing flow of the high pressure water from the vehicle to the cleaning head 88. The high pressure hose connection 110 is arranged above the centre point of the rotor arms 111 which are directly below. Therefore, the high pressure water enters the rotors at the connection point 110 and flows though the rotors arms 111. At the end of each rotor arm 111 is a high pressure nozzle 112 which is arranged at a 45° angle to the vertical plane, and which directs the high pressure water towards the surface to be cleaned. The rotor arms 111 are rotatably attached to the central point on the underside of the cleaning head 88, and the rotor arms 111 turn when in use.

The cleaning head 88 also has two connection points 113 for attachment of suction hoses. These suction hoses are attached to the vehicle and provide suction to the cleaning head 88 thereby removing dirty water.

The cleaning head 88 has arranged two handle securing points 114 on the top surface, one arranged either side of the central high pressure water hose connection point 110. The handle securing points 114 contain spring loaded pins and are able to attach to reciprocal securing mean on either a handle or the underside of a vehicle.

There is arranged a rubber squeegee blade 115 around the entire outer circumferential edge of the cleaning head 88. The squeegee blade 115 contains serrations which allow for air flow in to the underside of the cleaning head 88 thereby preventing formation of an excessive vacuum, and also ensuring ease of movement of the cleaning head 88 across the surface to be cleaned.

The cleaning head 88 has affixed at four equidistant points around the circumferential edge swivel castors 116 each with a wheel. These allow for ease of manoeuvring of the cleaning head 88 across a surface.

Referring to FIG. 8, there is shown a battery-powered wheeled vehicle 1 having a load-supporting chassis with a forward enclosed cab 2 and, behind the cab, a partially or fully enclosed van body 3.

The chassis supports an electric motor drivably connected to the wheels 4, a battery power source for the motor, and drive controls including a steering wheel contained within the cab 2 for use by a driver seated within the cab 2.

The van body 3 contains two large (1000 litre) water tanks, namely a supply tank 5 and a retrieval tank 6. The supply tank is provided with a filler inlet 7 and a supply outlet 8. The retrieval tank 6 is provided with a discharge outlet 9 and a retrieval inlet 10.

The van body 3 also contains a water heater 11 and a pressure pump 12 both of which are connected in line to a supply outlet 8 of the supply tank 5, and both of which are connected to a self contained diesel engine 12a via suitable controls.

The van body 3 further contains a suction device 13 which is connected to the retrieval inlet 10 of the retrieval tank 6. The suction device 13 has rotor blades within a housing with a tangential outlet and a central inlet. The suction device 13 is connected to the battery power supply of the vehicle via suitable controls. A shut off device is provided for stopping the suction device when the retrieval tank 6 is full.

The van body 3 further contains two flexible hoses 14, 15 on reels.

The equipment also includes a push-along cleaning head 16 which has an open-bottomed, ground engageable dome shaped cover 17 with side-projecting ground-engaging wheels 18.

The cover 17 has two, side by side, upwardly extending handles 19 by means of which the head 16 can be moved, manually, across a ground surface.

Under the cover 17 there is a star-shaped arrangement of, say, three horizontal arms 20 connected to and extending radially from the bottom of a vertical central tube 20a connected to a water inlet 21 on the cover 17. Water can flow down the tube 20a and along the arms 20 to be sprayed downwardly under pressure from jets 20b at the ends of the arms 20. The tube 20 is mounted under the dome 17 so that it rotates about its axis, causing the arms to rotate, under the action of the pressurised water.

Around the periphery of the cover 17 there is a narrow downwardly open channel 22 defined between inner and outer flexible, resilient rubber and plastics side walls 23, 24. Within the channel 22 there is a peripheral duct 25 having rows of downwardly facing narrow suction inlets 26 connected to a water outlet 27 on the cover 17.

The water inlet 21 and outlet 27 on the cover 17 are connected by respective hoses 14, 15 to the pressure pump 12 and the suction device 13. The hose 14 extends freely between the outlet 27 and the vehicle 1. The hose 15 extends along and is attached to one of the handles 19. A branch 15a of the hose 15 runs along and is attached to the other handle 19 and connects to an angled nozzle 20c fixed externally to the trailing end of the dome 17. Manual controls 15b, 15c are provided on the handles so that pressurised hot water can be directed to the arms 20 and/or the nozzle 20c.

Further operational controls may be provided on the handles 19 linked by electrical cables to control devices on the vehicle 1.

The cleaning head 16 can be stowed, when not in use, on the vehicle 1. When in use the cleaning head 16 is pushed over a floor- or ground-surface and the controls on the handles 19 are operated to cause heated water or steam to be fed to the outlet jets 20 under the cover 17, and dirty water is collected off the floor or ground surface by the suction applied through the suction inlets 26. The resilient side walls 23, 24 form a wiping seal with the floor or ground surface so that powerful suction can be developed within the channel 22. For removing stubborn contamination such as chewing gum, the nozzle 20c can be used to apply a high pressure, angled jet of hot water or steam.

On first use, the supply tank 5 is filled with clean water, introduced through the filler inlet 7, and the retrieval tank 6 is empty. During use, water is discharged from the supply tank 5 and dirty water is picked up and fed to the retrieval tank 6. After use, the retrieval tank 6 can be emptied through its discharge outlet.

It is envisaged that many of the features described with reference to FIG. 8 are also present in FIGS. 1 to 7 unless alternatives are specified. Therefore, the description of these common features additionally applies to FIGS. 1 to 7.

With this arrangement effective cleaning can be achieved in a convenient manner using equipment which is relatively simple and inexpensive to manufacture and maintain.

It is of course to be understood that the invention is not intended to be restricted to the details of the above embodiment which are described by way of example only.

1-17. (canceled)

18. Mobile cleaning equipment comprising:
a powered wheeled vehicle with an integral driver's cab containing vehicle drive controls;
water supply tank carried by the vehicle, a ground- or floor-engageable cleaning head having, beneath a cover, outlet jets and also a peripheral suction channel having, between spaced-apart flexible side walls, a plurality of suction inlets, a powered pressure pump connected between the water supply tank and the outlet jets of the cleaning head, at least one filter arranged between the water supply tank and said powered pressure pump, and a rotary suction device connected between the suction inlets and the water supply tank, wherein the equipment comprises a single tank divided by a membrane into separate compartments for water supply and water retrieval.

19. Mobile cleaning equipment according to claim 18, wherein the at least one filter is arranged to allow for the water to be filtered after it is used in the cleaning head.

20. Mobile cleaning equipment according to claim 19, wherein the at least one filter is a plurality of filters comprising for sequential removal of decreasing sizes of matter and material from the water.

21. Mobile cleaning equipment according to claim 20, wherein the plurality of filters comprises a first stage filter or pre-filter is arranged to filter dirty water on entry to the water tank after use in the cleaning head.

22. Mobile cleaning equipment according to claim 21, wherein the first stage filter has a filter size is in the range 100 to 200 μm.

23. Mobile cleaning equipment according to claim 22, wherein the first stage filter comprises one or a plurality of bag filters.

24. Mobile cleaning equipment according to claim 23, wherein the water supply tank has a retrieval inlet and on passing out of the retrieval inlet, the dirty water passes through the bag filters.

25. Mobile cleaning equipment according to claim 20, wherein the plurality of filters comprises a second stage filter having a filter size of 20 to 40 μm and a third stage filter having a filter size of 5 to 10 μm.

26. Mobile cleaning equipment according to claim 18, wherein the vehicle comprises a battery and the vehicle is a battery-powered vehicle.

27. Mobile cleaning equipment according to claim 26, wherein the powered pressure pump and the rotary suction device are both powered by direct current supplied by the battery.

28. Mobile cleaning equipment according to claim 18, wherein the rotary suction device is a suction or vacuum pump.

29. Mobile cleaning equipment according to claim 18, wherein the cleaning head cover is an open-bottomed dome structure and the outlet jets comprise multiple spaced apart jets distributed beneath the dome directed downwardly and these are at fixed positions or on rotatable arms.

30. Mobile cleaning equipment according to claim 18, wherein the cleaning head comprises at least one flexible resilient member arranged around the periphery of the cleaning head.

31. Mobile cleaning equipment according to claim 18, wherein the peripheral suction channel is arranged around a portion of the cleaning head.

32. Mobile cleaning equipment according to claim 18, wherein the mobile cleaning equipment comprises a water heater mounted on the vehicle for heating of the water prior to use in the cleaning head.

33. Mobile cleaning equipment according to claim 18, wherein the at least one filter is a plurality of filters comprising for sequential removal of decreasing sizes of matter and material from the water.
